(19) United States
(12) Patent Application Publication
(10) Pub. No.: US 2023/0421554 A1
(43) Pub. Date: Dec. 28, 2023

(54) AUTHENTICATION OF NODES IN A DISTRIBUTED NETWORK

(71) Applicant: Hewlett Packard Enterprise Development LP, Houston, TX (US)

(72) Inventors: Gareth David RICHARDS, Woodstock (GB); Christopher Anthony Grant HILLIER, Fort Collins, CO (US); Ludovic Emmanuel Paul Noel JACQUIN, Bristol (GB); Thomas M. LAFFEY, Roseville, CA (US)

(21) Appl. No.: 17/808,744

(22) Filed: Jun. 24, 2022

(51) Int. Cl. H04L 9/40

(52) U.S. Cl. CPC H04L 63/0876; H04L 63/0823; H04L 63/0435; H04L 63/062

(57) ABSTRACT

Examples for identification and authentication of hardware. Techniques may include receiving a node identifier during an initial phase of the node. The node identifier may include an initial unique identifier of the node. The node may receive a latest change identifier during a phase change of the node, wherein the phase change may cause a hierarchical change of the node. The latest change identifier is configured to incorporate a latest unique identifier corresponding to a latest system and one or more unique identifiers corresponding to one or more earlier systems of the node. Further, responsive to the reception of the latest change identifier, delete an earlier change identifier, and the node may send the second change identifier to a management service, in response to a request for authentication of the node by the management service.

### BACKGROUND

A distributed network may refer to a technology used for linking multiple computing devices that are either concentrated or spread across a network. These multiple computing devices may form a cluster that can be used for storing data, coordinated processing, networking, etc. Such clusters can be scalable, resilient, etc. while making them cost-effective. Distributed systems can tackle changes in demand from users/enterprises. For example, when a user wants to scale their storage capacity, an upgraded storage cluster can be offered without physically upgrading the storage.

### BRIEF DESCRIPTION OF THE DRAWINGS

The present disclosure, in accordance with one or more various examples, can be described in detail with reference to the following figures. The figures are provided for purposes of illustration only and merely depict examples, wherein:

FIG. 1 illustrates a schematic view of a network environment, according to various examples of the present disclosure;

FIG. 2 illustrates a flow diagram depicting a method of authentication of a node, according to various examples of the present disclosure;

FIG. 3 illustrates a schematic view of a network deployment with nodes, in accordance with various examples of the present disclosure;

FIG. 4 depicts a schematic view of an example interaction between various components for provisioning of unique identifiers to a node, according to the present disclosure;

FIG. 5 illustrates a schematic view of a node with identifiers representing hierarchical relation of a node, in accordance with various examples of the present disclosure;

FIG. 6 illustrates an example flow diagram for a method of providing cryptographic identities to a node and an authentication process of the node, per the present disclosure; and

FIG. 7 depicts a block diagram of an example computer system in which the disclosed hierarchical identification and authentication techniques may be implemented.

The figures are not exhaustive and do not limit the present disclosure to the precise form disclosed.

### DETAILED DESCRIPTION

With exponential growth in the adaptation of cloud services and their use in various applications, scalable systems such as distributed computing, network, and/or storage systems are proliferating. Various users and enterprises may rely on cloud services, for example, storage-as-a-service, which offers them the flexibility to scale up/down based on their requirements. These scalable systems may include various electronics systems coupled to form a cluster. “Electronic systems” can be computing devices, servers, storage devices, and/or hyperconverged systems. “Hyperconverged systems” can be a combination of storage, computing, and/or networking devices put together to serve an application. Electronic systems deployed in a cluster may be referred to as nodes. Various nodes may be connected by wired and/or wireless networks, such as a Local Area Network (LAN), a Wide Area Network (WAN), a Storage Area Network, or the like.

One example of such a network is Storage Area Network, which may comprise a storage cluster to store data originating from one or more client devices. A storage cluster may include a plurality of nodes and each node may manage one or more logical storage clusters. In the storage cluster, user data may be distributed across nodes (e.g., storage nodes). Nodes that form a storage cluster can be housed within the same chassis or across multiple chassis. In some instances, these nodes may be deployed at the Edge (e.g., location close to a data source), regional data centers, distributed data centers, and/or distributed across locations. Further, multiple clusters may be grouped to form a cluster group, multiple cluster groups may form a federation, and so forth.

In such distributed systems with hierarchical deployment (e.g., various levels/phases, such as enclosure, cluster, cluster group, federation, etc.), identification, authentication, and/or authorization of nodes can be challenging. For example, an unsecured and/or unauthenticated node may be deployed in a network and such a node can become a security threat to the network and user data. Moreover, the use of redundant computing modules (e.g., compute blades) within a node may pose added complexity for identification and/or authentication.

A cryptographic identifier, for example, a manufacturer-installed Initial Device Identifier (IDevID) based on the Institute of Electrical and Electronics Engineers (IEEE) 802.1AR standard can be used for the identification of a node and for authenticating itself during communication and/or when connected to a network. However, a node may not be able to provide hierarchical information related to its deployment, for example, because the node may have limited information regarding its deployment. In one example, a node may be merely aware of an enclosure in which the node is deployed. Thus, per some of the existing systems, information about the deployment in an enclosure can be insufficient/limiting to provide hierarchical information, especially in a distributed system architecture. To mitigate such shortcomings, in some other systems, a management service may be used to maintain records of devices and their hierarchal structure, for instance, in a database. However, maintaining such records can be burdensome, considering the scale at which the distributed systems may operate. Moreover, some of the existing processes of recording cluster inventories, maintained by management services, may be prone to errors.

In some multi-node architectures, a node may be selected as a cluster leader, which may be used to represent the cluster. When a cluster leader fails, a new node may take over as the cluster leader. In such instances, the new cluster leader may present an identifier to a remote service, and the identifier would be different and may contain any representation of the broader cluster. Moreover, the remote management service may not be aware whether the new cluster leader is a member of the same cluster as the previous leader—unless the remote management service maintains an inventory record. However, as discussed earlier, maintaining records of inventory may have associated shortcomings.

Further, in some other multi-node architectures, a cryptographic identity of a single node may be used to represent the multi-node architecture (e.g., a cluster). For instance, in a High-Performance Computing (HPC) cluster, a cryptographic identity of a single node may be used to represent a cluster. This may be possible by virtue of the hardware configuration of the HPC. However, in certain multi-node distributed technologies, such as distributed storage, a single node representation may not be applicable. In distributed storage, various remote endpoints that are connected to the distributed storage may have to be aware of the hierarchical relation and architecture of the multi-node distributed storage. Moreover, addition of remote management services may impact the effectiveness of identification/authentication of the multi-node architecture. This may further impact cloud management capabilities, field repair, and/or replacement processes of the multi-node architecture.

The present disclosure provides techniques for zero-touch identification and authentication of nodes in a network such that trusted devices may be allowed to join a system, for example, a cluster of related nodes. For example, a node can be a compute node, a storage node, or the like. A node may go through various phases, such as a manufacturing phase, and one or more subsequent deployment phases. With a phase change, a hierarchical relationship of the node may change. According to examples of the present disclosure, during an initial phase, a node may be provisioned with a node identifier. As used herein, an initial phase can be a starting stage in a life cycle of a node. For example, a manufacturing stage, a stage after factory reset that reverts a node to factory settings, or the like can be considered as the initial phase of a node. The node identifier can be a permanent identifier of the node. Further, to aid in the identification/authentication of a node irrespective of a phase of deployment of a node, the node may be provisioned a change identifier at each phase, which may be cryptographically bound to the device. A hierarchical information of a node is bound to that particular node by a change identifier. Further, when a node undergoes a phase change, a latest change identifier may be provisioned that replaces/complements an earlier change identifier, without affecting the node identifier. A latest change identifier stores previous hierarchical information of the node deployment. Thus, a change identifier supplements the node identifier, and it enables the node to be uniquely identified.

According to techniques of the present disclosure, a node is capable of authenticating itself by presenting hierarchical information through secure and reliable identifiers (e.g., cryptographic identifier(s)) whereby maintenance of records for hierarchical information can be reduced or eliminated. Consequentially, with a reduction in usage of records, shortcomings associated with record maintenance (e.g., errors) can be avoided. Further, when a new cluster leader is elected, an endpoint (e.g., remote management service) can recognize hierarchical information of the new cluster leader (e.g., whether the new cluster leader belongs to the same cluster as earlier cluster leader) during authentication thereby granting appropriate privileges. Techniques of the present disclosure enable effective identification/authentication mechanism for multi-node architecture(s), which may be distributed. Moreover, hierarchical information offered by a node may improve cloud management capabilities, such as field repair and/or replacement processes, due to the ease of locating a node, per some examples.

In some examples, during an initial phase, for example, a manufacturing phase, a node may receive a node identifier (e.g., an IDevID and/or IDevID certificate). In an example, the node may be provisioned with a signed digital certificate associated with the node, which can serve as a trusted form of identification of the node. The node identifier is an immutable certificate, which may not change for the entire lifecycle of the node. The process of provisioning a node identifier may include generating and installing the signed digital certificate during the manufacture of the node (e.g., before the node leaves the manufacturing facility). During a subsequent phase (e.g., deployment in a physical and/or a logical system), the node may be configured to receive a change identifier (e.g., Locally significant Device Identifier (e.g., LDevID) and/or LDevID certificate) that complements the node identifier. In an example, the process may include generating and installing a signed digital certificate to the node. The signed digital certificate may bind the hierarchical identity of the node to a public key. Based on a further change in a phase of the node, the node may receive a latest change identifier (e.g., an LDevID) by way of re-issuance. The latest change identifier replaces the earlier change identifier.

In some examples, responsive to a phase change, the node may trigger a request for provisioning of the latest change identifier. In some other examples, a network console or a remote management service may identify a change in the phase of a node and trigger a request. In one example, a latest change identifier of a node incorporates/stores information corresponding to a unique identifier of a current phase and one or more unique identifiers of previous phase(s). Thus, a node maintains a single change identifier that enables authentication and hierarchical tracking of the node. Moreover, during an authentication request, a node may use the latest change identifier, which may provide hierarchical information associated with the node, for authentication. Accordingly, based on the identification and/or authentication of a node, access, and other privileges may be granted to the node. Further, with the addition of multiple endpoints or remote management services, each node in the multi-node architecture can identify and authenticate itself and present its hierarchical relationship in the architecture.

According to some examples of the present disclosure, a node may include a processor, for example, a Central Processing Unit (CPU), and a security co-processor. The processor may cause the security co-processor may generate a cryptographic key or key pair that can be used as a change identifier when a phase change occurs. A change identifier certificate may be issued to a node using a cryptographic key, such as a public key of an asymmetric key pair. In some examples, the techniques may include, receiving a node identifier (e.g., IDevID) that incorporated a unique identifier (e.g., a serial number) of a node. Further, the node may receive a first change identifier when deployment of the node occurs in a first system. The first change identifier can be a Locally significant Device Identifier (e.g., LDevID) that incorporates a unique identifier of a first system and the unique identifier of the node. When a node undergoes a further phase change, a latest change identifier (e.g., a second change identifier) may replace an earlier change identifier (e.g., the first change identifier) thereby maintaining a single change identifier. The latest change identifier may be configured to preserve the hierarchical information of the node. Further, when a remote service requests authentication of a node, the processor may send the latest change identifier to the remote service. The remote service can be a networked management service, a cloud-based management service, an administrator service, or the like.

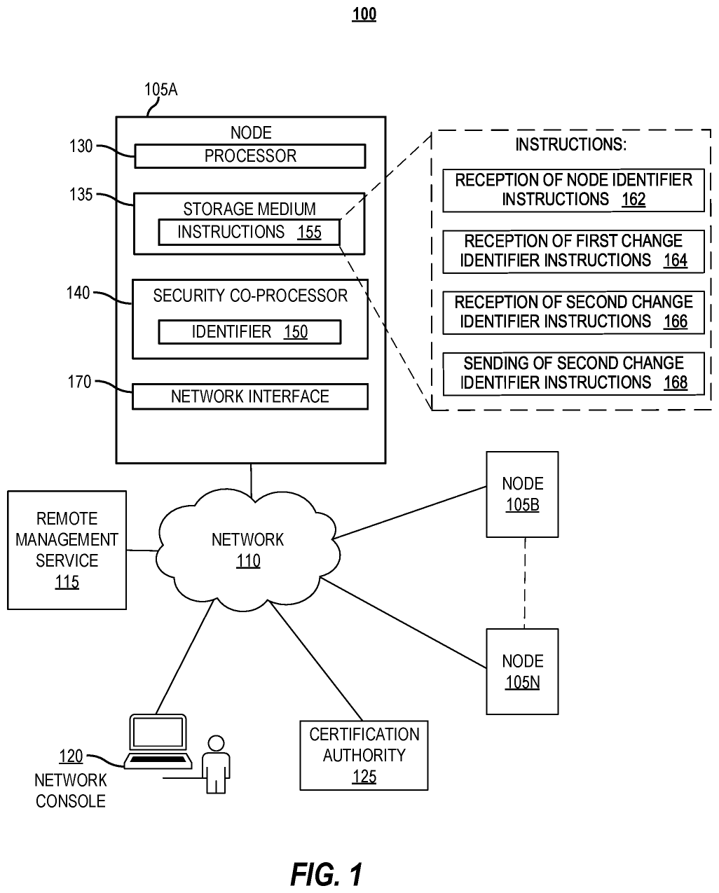

FIG. 1 illustrates one example of a network environment in which techniques disclosed herein might be implemented. The network environment 100 may include a plurality of nodes 105A-105N. One or more nodes may be configured to identify and/or authenticate themselves at a hierarchical level of its deployment, as per the techniques disclosed herein. This plurality of nodes 105A-105N may be provisioned in network environment 100 to perform a specific operation. For example, the plurality of nodes 105A-150N may be storage nodes configured to offer cloud storage to one or more users. In further examples, the plurality nodes 105A-105N may be configured to support on-demand and/or scalable as-a-Service (aaS) applications, such as Storage-aaS (SaaS), Infrastructure-aaS (IaaS), Software-aaS (SasS), Platform-aaS (PaaS), or any other cloud-native services.

According to some examples, the plurality of nodes 105A-105N may be connected to a network 110. The network 110 can be a wired or a wireless network. Further, the network environment 100 may include a Remote Management Service (RMS) 115 for managing and/or supervising the plurality of nodes 105A-105N. In some examples, the RMS 115 may enroll and/or provision one or more of the nodes 105A-105N based on service requirements. Alternatively, in some examples, a network console 120 may be provided alongside RMS 115 or in absence of RMS 115 for enrolling and/or provisioning of the nodes 105A-105N. In some examples, a user may access these services via a client device. Examples of a client device may include a computing device, a server, a portable communication device, a smart device, an Internet of Things (IoT) device, or any other data processing capable device.

Further, the plurality of nodes 105A-105N may be deployed at multiple physical or geographical sites. The network environment 100 may include a primary site in communication with the network 110. In an example, one or more nodes of the plurality of nodes 105A-105N may be deployed in the primary site. In some other examples, the network environment 100 may also include one or more remote sites that are in communication with the network 110. In one example, a cloud service provider with scalable resources may deploy one or more clusters (and cluster groups) that may spread across a primary site and one or more remote sites. As used herein, a ‘cluster,’ may refer to a group of interconnected nodes that work together to support generic or specific application(s) and/or middleware.

In some examples, the network environment 100 may be a remote service network, such as a cloud service network. One or more client devices (not shown) may communicate with the nodes 105A-105N via the network 110. The network service may correspond to storage, compute, networking, and/or any other computing services. The network environment may act as a platform that provides scalable resources to the client devices.

Per some examples, each node 105A-105N may include a processor 130 and a storage medium 135. The processor 130 can fetch, decode, and execute instructions from the storage medium 135. The instructions when executed cause the processor 130 to perform one or more specific operations. Further, the node 105A may include a security co-processor 140. In some examples, the security co-processor 140 may be independent of the processor 130. The security co-processor 140 may be configured to generate and/or store a device identity with hierarchical information. The term ‘hierarchical information’ may correspond to information related to various phase changes (e.g., various levels of deployment) undergone by a node during its deployment. The security co-processor 140 may store a device identity (e.g., an identifier 150 comprising hierarchical information) in a secure/tamper-proof manner. The term “secure” may indicate that it can be protected from unauthorized access. The identifier 150 stored in the security co-processor 140 may be used for the identification and authentication of the node 105A. In some examples, the security co-processor 140 may interact via an Input/Output (I/O) buffer that uses a well-defined formatting. The security co-processor may operate based on (series of) command(s) it receives.

In the ongoing example, the node 105A may include a non-transitory machine-readable storage medium (e.g., the storage medium 135) that can store instructions 155. The instructions 155 may include reception of node identifier instructions 162, reception of a first change identifier instructions 164, reception of second change identifier instructions 166, and sending of second change identifier instructions 168, as per some examples. The node 105A may include one or more interface(s), such as a network interface 170 (e.g., Network Interface Card (NIC), network port, a wireless communication component, etc.) for communication with other devices or entities connected to the network 110.

According to some examples, the processor 130 may execute the reception of node identifier instructions 162. For example, at the manufacturing phase of the node 105A, the node 105A may receive a node identifier from the manufacturer. The node identifier can be an electronic credential, such as a certificate, installed by a manufacturer. The node identifier may incorporate an initial unique identifier of the node 105A. In one example, the initial unique identifier may use a unique serial number of the node 105A. In other example, the initial unique identifier may use a combination of a unique serial number, a model, and manufacturer details. For example, the node 105A may be processed during its manufacture with a signed certificate. The certificate may be associated with the node 105A and can serve as a trusted form of identification for the node 105A. For instance, the processor 130 may cause the security co-processor to generate a key pair. Out of the generated key pair, a public key may be used for encryption and a private key can be used for signing. In some examples, the processor 130 may execute one or more instructions that cause the security co-processor 140 to generate a key pair.

According to some examples, the processor 130 may execute the reception of first change identifier instructions 164. The execution of the reception of first change identifier instructions can be responsive to a change in phase of the node. In some examples, the node 105A may be subject to a phase change (e.g., a first phase change) when it may be deployed in the field, such as on-premise, at a data center, the Edge, etc. For example, in the field, node 105A may be deployed to a chassis (e.g., a first system). The chassis can be a physical enclosure capable of holding one or more nodes. Responsive to such phase change, the security co-processor 140 may receive the first change identifier based on a first phase change of the node 105A. The first change identifier may use a unique reference associated with the first system. In some examples, a first certificate may be issued for the first change identifier such that the certificate (e.g., an X.509 certificate) binds an identity to the public key using a digital signature. The private key may be securely stored locally on the node 105A at a secure storage, such as BMC or similar secure storage means or the security co-processor 140 itself. The first change identifier may enclose the first unique identifier of the first system. The first change identifier may be associated with the node identifier that may be issued during the manufacturing phase. In a further example, the node identifier may be used to validate whether a private key of the first change identifier is securely stored in the security co-processor 140. According to a particular example, a proofing command, such as tpm2_certify, may be triggered by a processor or via network console to the security co-processor. The security co-processor may return a proof that the private keys of both the node identifier and the change identifier are available and can be usable in the security co-processor. Such proof returned by the security co-processor can be signed by the node identifier. In yet another example, a BMC can be configured to receive such proofing command and to respond with a proof to validate secure storage of private key(s).

According to some examples, the processor 130 may execute the reception of second change identifier instructions 166. In the field, the node 105A may be subject to a further phase change (e.g., a second phase change) when it may be provisioned to join a cluster (e.g., a second system). In some examples, ‘provisioning’ may refer to the creation of a new cluster or adding a node to an existing cluster. Responsive to such further phase change, the security co-processor 140 may receive a second change identifier based on a second phase change of the node 105A. The second change identifier can be a reissued/new change identifier for the node 105A. The second change identifier may replace the first change identifier. However, the second change identifier may enclose data from the first unique identifier of the first system and also, another unique identifier (e.g., a second unique identifier) of the second system. The certificate may enclose such hierarchical information using various unique identifiers. Thus, after re-issuance, the node 105A may use the second change identifier, which may be a single cryptographic identifier, for authentication and identification.

According to some examples, the processor 130 may execute the sending of second change identifier instructions 168. The node 105A, such as a storage node may use a single cryptographic identifier for various authentication use cases. For instance, the RMS 115 may request authentication from the nodes 105A to distinguish a node based on its hierarchical configuration. Responsive to such requests from a remote service, the security co-processor 140 may send the latest change identifier (the second change identifier, per ongoing example). In an example, the latest change identifier may be used as a “client” certificate to identify the node to a management entity/service, such as the RMS 115. Further, a cryptographic protocol, such as Transport Layer Security (TLS), a mutual TLS (mTLS), a mutually-authenticated TLS, or the like, may be used for the network connection between the node 105A and the RMS 115 for such identification process. The RMS 115 may grant appropriate privileges based on successful authentication and hierarchical configuration of the node 105A. Nodes 105B-105N may share the same configuration or with varied configurations but the same capabilities as the node 105A, as discussed herein.

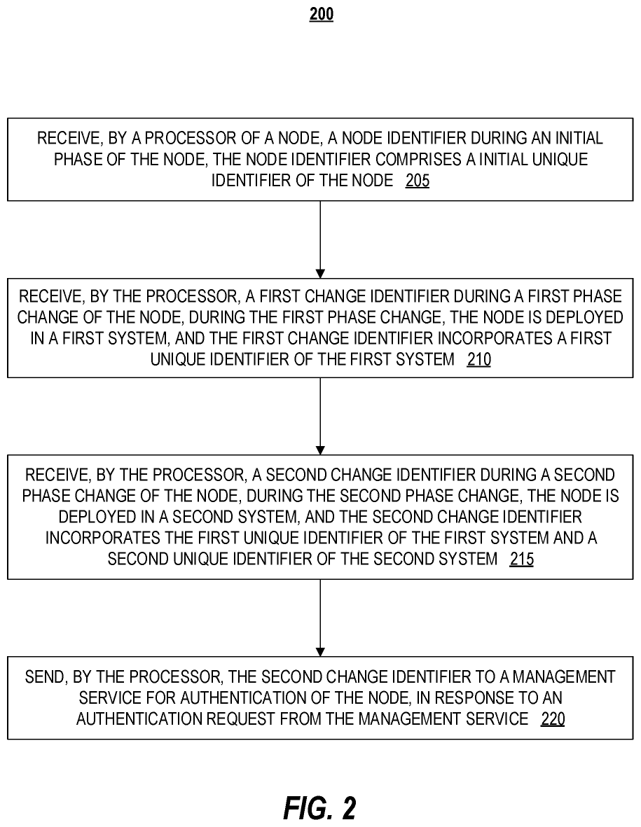

FIG. 2 illustrates a flow diagram depicting method 200 of authentication of a node, according to various examples of the present disclosure. In some examples, the method 200 may be encoded as instructions in a machine-readable storage medium. The instructions may be executed by a processor (e.g., the processor 130 of FIG. 1).

Now referring to the method 200, according to some examples, at block 205, the processor may receive a node identifier during an initial phase of the node. The initial phase can be a manufacturing phase. Subsequent phases of the node during field deployment may be referred to as, ‘first phase,’ ‘second phase,’ ‘third phase,’ etc. In an example, a Public Key Infrastructure (PKI) may be used for binding a public key with an identity of the node. The binding may be achieved by registration and issuance of certificate(s) by a CA. In some examples, the processor may execute instructions that cause a security co-processor to generate a key pair. Of the generated key pair, one key may be used for encrypting data using a cryptographic algorithm and other keys may be used for decrypting such data. For instance, a public key may be used for signature verification and a private key out of the key pair can be used for signing.

In some examples, the node, at the manufacturer phase, may receive a node identifier, such as a Device Identifier (DevID) that is based on an IEEE 802.1AR standard. The node identifier can be an IDevID, and the node identifier may be infeasible to be forged or transferred to another node. In one example, the node identifier can be an electronic credential, such as a combination of a certificate and a private key, installed by a manufacturer. One key may be used for encrypting data using a cryptographic algorithm and other key (e.g., a private key) may be used for decrypting such data. For instance, a public key may be used for signature verification and a private key out of the key pair can be used for signing. In some examples, a key pair may be generated by the security co-processor.

Further, in some examples, to securely associate a public key with an identity and the DevID, a certificate binds the device identity to the public key. A certificate can be an IDevID certificate. The certificate may include public key information, a device owner's information, supporting encryption or signing algorithm, conditions for revocation/validity of a certificate, and/or a signature of a certificate issuer/CA. For example, the device owner's information may include an identity that may be referred to as a ‘subject.’

According to some examples, at block 210, the processor may receive a first change identifier during a first phase change of the node. During the first phase change, the node is deployed in a first system. The first change identifier incorporates a first unique identifier of the first system. The node may be subject to a phase change (e.g., a first phase change) when it may be deployed in the field, such as on-premise, at a data center, the Edge, etc. For example, in the field, the node may be deployed to a chassis. The chassis can be a physical enclosure capable of holding one or more nodes. In some examples, a security co-processor may be used to receive the first change identifier based on a first phase change of the node. A first certificate may be issued for the first change identifier. The first change identifier may be associated with the node identifier.

According to some examples, the first change identifier can be a cryptographic identifier, such as LDevID that uses a chassis serial number. In some examples, the chassis may include a memory unit (e.g., an Electrically Erasable Programmable Read-Only Memory (EEPROM)) that stores a serial number of the chassis for uniquely identifying the chassis. The memory unit may be communicatively coupled to the node. In another example, the chassis may include a security attribute that may be included in a certificate. In some examples, an X.509 certificate standard may be used and, a security attribute may be included in a Subject Alternate Name (SAN) field of the certificate. As per one example, the security attribute may be a unique name or a common name of the chassis. This security attribute may be included in the certificate as a SAN extension.

According to some examples, at block 215, the processor may receive a second change identifier during a second phase change of the node. During the second phase change, the node may be deployed in a second system. That is, per one example, the node may be subject to a further phase change (e.g., the second phase change) when it may be provisioned to join a cluster. The second change identifier incorporates a first unique identifier of the first system and a second unique identifier of the second system. For example, the node can be a storage node and it may become part of a storage cluster. Responsive to such phase change, the security co-processor may generate a key pair. Further, a public key of the key pair and other hierarchical information of the node may be sent to an appropriate authority (e.g., a Certification Authority (CA) 125) for signature. The node may receive the second change identifier from the signing authority. In one example, a second certificate may be received that encloses signed public keys and the certificate may be used to bind device identity (e.g., hierarchical information) with a public key generated by the security co-processor.

According to some examples, at block 220, the processor may send the second change identifier to a remote service for authentication of the node. Sending action may be based on certain authentication use case conditions or in response to an authentication request from the remote management service. In one example, the remote management service can be the RMS 115 as illustrated in FIG. 1. The processor may use a latest change identifier and/or a corresponding certificate of the node for identification/authentication. In the current example, the latest change identifier is the second change identifier. Whereas, in another example, if the node undergoes four-phase changes in the field, the latest change identifier can be a fourth change identifier. In such instances, the processor may send the fourth change identifier for authentication. Notably, usage of the node identifier (e.g., the IDevID) can be limited. Moreover, an initial private key of the node identifier may not be used for identification/authentication purposes thereby reducing or eliminating leakage of a private key.

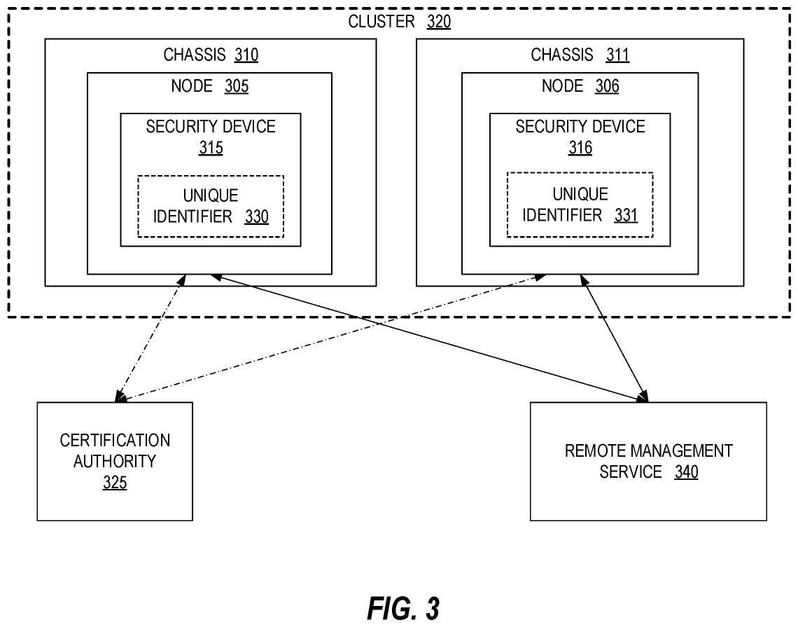

FIG. 3 illustrates a schematic view of network deployment with nodes, in accordance with various examples of the present disclosure. The network may include a plurality of nodes. In the ongoing example, two nodes 305, 306 are depicted for brevity and not by way of limitation. In some examples, each node 305, 306 may be deployed to a chassis 310, 311. For example, the node 305 may be deployed on the chassis 310 and similarly, the node 306 may be deployed on the chassis 311. In some examples, the nodes 305 and 306 may be provisioned to support a workload, such as a cloud storage, cloud computing, etc. Further, in some examples, the nodes 305 and 306 may be deployed in the same cluster. In some other examples, nodes from different chassis 310 and 311 may be provisioned to work as a cluster 320. For example, each node 305, 306 can be a storage server and they might be provisioned to join one or more logical storage cluster(s).

As discussed in earlier examples, the node 305, 306 may contain at least one processor. The processor can be configured so that it can execute instructions encoded on a storage medium. Further, the nodes 305, 306 may include a security device, which, for example, is a Trusted Platform Module (TPM). In some examples, the nodes 305, 306, at the factory phase, may each receive a node identifier, for example, an IEEE 802.1AR based IDevID. The identifier provision before leaving a factory can be a node identifier (e.g., an IDevID), and the node identifier may be infeasible to be forged or transferred to another node.

In accordance with the illustrative example, the node may be at least one of a server, a networking switch, a computing node, a mobile device, a handheld device, a portable device, a non-portable device, a server desktop, a desktop computer, or any other processing devices with a non-transitory storage medium, or similar component(s). Other end of a network connection may be at least one of a cloud-based management server, managing, for example, compute or storage nodes, another node in the cluster, a remote node, a server, a computing node, a client node, a monitoring node, a mobile device, a handheld device, a portable device, a non-portable device, a server desktop, a desktop computer, a computer cluster, a console, a handheld console, a central node, a central monitoring system, or any other processing devices.

The endpoint mentioned above may be linked to the node via a communication link. The communication link may be a wired communication link, a wireless communication link, or a combination of wired and wireless links. The communication link may be in accordance with a wireless communication standard such as IEEE 802.11a, IEEE 802.11b, IEEE 802.11g, IEEE 802.11n, IEEE 802.11ac, IEEE 802.11ax, IEEE 802.11be, High-Performance Radio LAN (HiperLAN), or other wireless communication standards. The communication link may be established via a communication network such as data networks, wireless networks, telephony networks, a public data network such as the Internet, Local Area Networks (LANs), Wide Area Networks (WANs), Metropolitan Area Networks (MANs), cable networks, fiber optic networks, cellular networks, satellite communications, wireless LANs, combinations thereof, or the like. Further, the communication link may be established and implemented via a communication protocol such as TCP/IP, HTTP, Ethernet, USB, FireWire, or other similar protocols.

In some examples, the security device can be sometimes referred to as a security co-processor. In some other examples, the node can be a server and may include a Baseboard Management Controller (BMC) and/or a Trusted Platform Module (TPM). At least one of the BMC and the TPM may be configured to operate as a security device. In another example, a node may include both the BMC and the TPM, and at least one of the BMC and the TPM may be provisioned with the node identifier and the change identifier(s).

A processor of a node may interact with and cause a security device to perform certain cryptographic operations, such as generation of a key pair, signing, etc. In one example, a processor may interact with a TPM to perform cryptographic operations and the TPM may act as the security device. In another example, a processor may interact with a BMC to perform certain cryptographic operations. The BMC may include a security subsystem that is configured to perform various cryptographic operations and the security subsystem may act as the security device.

According to some examples, each node 305, 306 may comprise a TPM that may be configured to be a security device (e.g., the security device 315, 316). The TPM may be a secured crypto-processor, alternatively referred to as a “TPM security device.” A TPM can perform cryptographic operations to store secure information that may be used to authenticate a node in the network. According to some examples, the TPM may interact through well-defined commands/Application Programming Interface (API). The TPM behavior may be exclusively based on the (series of) command(s) it receives. According to some examples, the TPM may store secure information, such as signing keys, certificates, etc. When any of the node 305, 306 undergoes a phase change, as per examples described herein, the node 305, 306 may be provisioned with a unique identifier that identifies a hierarchical phase change. For instance, the node identifier (not shown) can be a factory-provisioned device identity, and the change identifiers 330, 331 can be a field provisioned used for hierarchical identification. Per IEEE 802.1 AR protocol, a CA may digitally sign a public key to enable other devices in a network to trust that a particular public key corresponds to a particular owner of the public key and associated identifier. A CA may issue certificates to each of these identifiers that are bound to an identity used to identify a node. As per some examples, the security device may receive a certificate authenticating the device identifiers.

According to some examples, the node 305, 306 may each have a node identifier that may be factory installed. Further, the nodes 305, 306 may have a change identifier (e.g., a first change identifier, a second change identifier, etc.) that may be provisioned during a phase change of the nodes 305, 306. According to some examples, the node identifier is used to uniquely identify each of the nodes 305, 306. Whereas, the change identifier 330, 331 may uniquely identify the node along with its hierarchical relation in a network. In some examples, generation of the node identifier or change identifier may include the generation of a key pair. A public key out of the key pair may be signed by a certification authority 325.

According to some examples, when the node 305, 306 undergoes a phase change, an existing change identifier of the node may be replaced by a newly generated (alternatively, referred to as ‘latest’) change identifier. The latest change identifier incorporates the latest phase information along with previous hierarchical information. As per some examples, a certificate issued to the latest change identifier incorporates unique references of various systems the node 305, 306 is part of. Further, a Remote Management Service (RMS) 340 may distinguish a node based on hierarchical configuration (e.g., a chassis, a cluster, a cluster group, etc.). Further, based on the hierarchical configuration of a node, the RMS 340 may grant privilege(s) to perform one or more operations with appropriate nodes.

As used herein, “appropriate nodes” may refer to nodes that may be within the same cluster as that of the node being granted privileges. Example uses may include load balancing, high availability (HA) server applications, storage, parallel processing, or other computing applications. Nodes of a given cluster may be connected by public network fabric and communicate with each other via secure connections. A node in a cluster may have read, write, and/or access permission, which can be based on an application, service, user, server, or any other endpoint. In a further example, a node may be a storage node of a particular cluster, and the storage node may be restricted to setting up secure connections with other storage nodes of the same cluster for purposes of performing certain operations, such as replicating data, balancing data, and so forth. Moreover, a storage node may be restricted to form secure connections with a particular subgroup of storage nodes of the cluster.

In some examples, a node (e.g., the node 305) may be decommissioned from an allocation due to maintenance, service, or upgrade conditions. After decommissioning, the node 305 may be re-deployed in another hierarchical deployment. For instance, the node 305 may be removed from the chassis 310 and may be deployed in the chassis 311. Accordingly, the node 305 may further be provisioned to be part of an earlier cluster or in a new cluster. In such conditions, the security device may be configured to check the validity of a change identifier that may be available on the node 305. Based on the condition that the change identifier does not match hierarchical deployment information, the node may request a factory reset from a remote service or may perform a voluntary factory reset. This may cause deletion of the change identifier(s) but the node identifier may be available. Deletion of the change identifier(s) may include revocation of corresponding certificates. Further, a latest change identifier (and corresponding key pair) may be generated by the security device, and a certificate may be received for the latest change identifier that identifies the node by its modified hierarchical information.

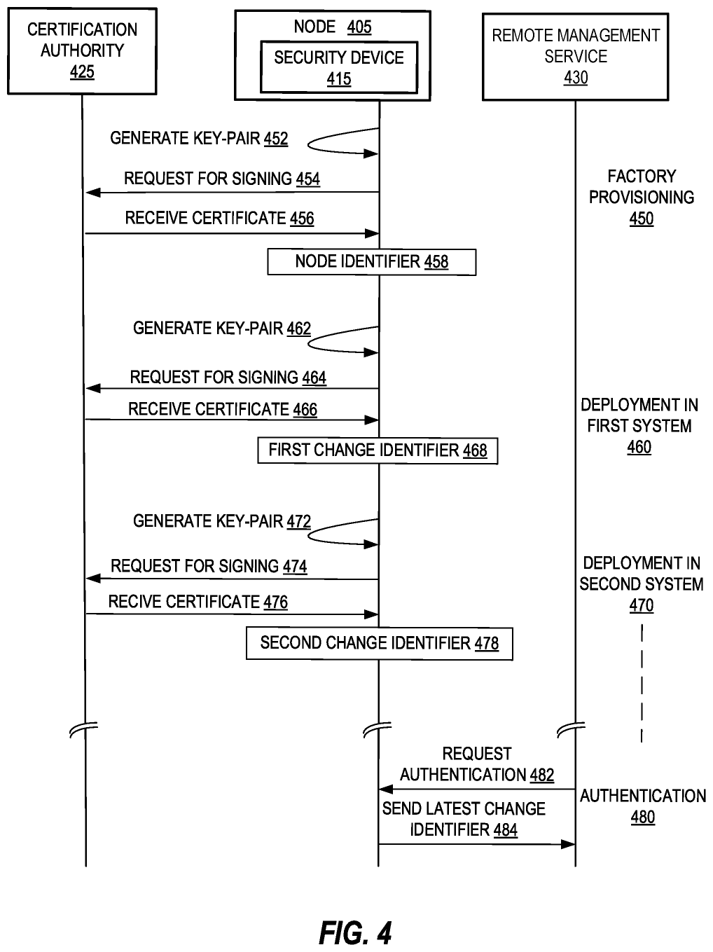

Referring now to FIG. 4, a schematic view of the interaction between various components for the provision of a unique identifier to a node is depicted, according to various examples of the present disclosure. A network may include a plurality of nodes that are deployed in various phases and various clusters in the field. For example, the network may include a plurality of nodes that are distributively deployed in various enclosures and each node may be part of one or more clusters. In the current example, one node (e.g., a node 405) may be depicted for brevity. A Certification Authority (CA) 425 may be responsible for issuing certificate(s) for a node to bind an identifier to a cryptographic key in a network. In some other examples, certificates may be issued by different CAs at different phases.

According to some examples, the node 405 may be factory provisioned 450 with a node identifier, such as an IDevID. The node identifier can be a permanent identifier that may be securely stored in the security device 415 throughout the life of the node 405. As discussed earlier, the security device 415 can be a TPM. The node 405 may generate a key pair 452. The node 405/manufacturer may send a request to a certification authority 425 for signing a node identifier-related public key. The certification authority 425 may sign the public key and send it. In an example, the node 405 may receive the node identifier, which comprises the public key enclosed in an initial certificate. In some examples, instead of a CA, the manufacturer of the node 405 may sign the public key(s) and provide an initial certificate. For instance, the manufacturer may request a signing of the node identifier 458. The certification authority 425 may sign the node identifier 454. The node 405 receives the initial certificate 456 for the node identifier 458.

Further, during deployment in the field, the node 405 may leave the manufacturing facility or factory with this factory-provisioned certificate. A node may be provisioned with a change identifier, at least when a node undergoes a phase change. For instance, when a node undergoes a phase change, a latest change identifier may be issued that replaces an earlier change identifier. Thus, a node may store a single change identifier that incorporates the latest hierarchical information of the node.

In the ongoing example, the node 405 may further be deployed in a first system 460. The first system 460 may be a physical system/deployment, such as an enclosure, or a logical system, such as a cluster. Further, the first system 460 can be at least one of a chassis, a rack server, a blade server, and a group of physical nodes. Further, responsive to a phase change, the security device 415 may generate a key pair for a change identifier (e.g., a first change identifier) of the node 405. In the ongoing example, the node 405 may trigger a communication request. Such communication with a request for signing 464 may be transmitted to a device/server associated with the CA 425 along with appropriate details. The node 405 may receive a first certificate 466, which may be related to the first change identifier 468. The first certificate may link a public key and an entity (e.g., manufacturer, domain name, etc.) signed by a trusted entity.

In an example, the first change identifier and the first certificate may be stored in a local storage of the node 405. In some examples, a network console or a Remote Management Service (RMS) 430 may trigger a communication request for the signing of key(s), in response to an identification of a phase change of the node 405. In an example, a node adjacent to a newly deployed node (e.g., the node 405) may notify a management service of a “hot swap event.” The management service (e.g., the RMS 430) may trigger a request for authentication of the node 405. In one example, the authentication request may be followed by a Certificate Signing Request (CSR) for the node 405. The CSR may be forwarded to the CA 425 for signature and returned to the node 405.

Further, during deployment in a second system 470, the node 405 may undergo a further phase change. For example, the node 405 may join a cluster. Responsive to this phase change, the node 405 may cause generation of a key pair 472. In an example, a processor of the node 405 may cause the security device 415 to generate a key pair. Responsive to phase change, the node 405 may trigger a request for signing 474 a public key by sending public key and other hierarchical information of the node 405. Consequently, the node 405 may receive a second certificate 476 for the change identifier (e.g., a second change identifier) from the CA 425. The second certificate binds the first unique identifier and the second unique identifier to a public key of the second key pair. The second certificate may enclose signed public keys and other hierarchical information with authenticity.

Further, the latest change identifier (e.g., the second change identifier 478) may replace an earlier change identifier (e.g., the first change identifier 468) when the node 405 undergoes a system-level change. Thus, during a life cycle of the node 405, the node identifier 458 may be used to identify the node 405 and a latest change identifier may be used to identify the hierarchical deployment. Further, the hierarchical deployment may be used to enable/disable access to other nodes in the same enclosure or to other nodes that are part of the same cluster but in a different enclosure(s). That is, a node that is not part of a specific cluster may not be authorized to access specific cluster data or communicate with other member nodes of that cluster.

Thus, during an authentication 480 of the node 405, the RMS 430 may request authentication 482 of the node 405. In response, the node 405 may send the latest change identifier 484 for hierarchical identification and authentication. This authentication mechanism enables cryptographic device identification. The private key of the change identifier and the node identifier may be securely stored in a tamper-proof cryptographic coprocessor, such as a TPM. Thus, nodes from Original Equipment Manufacturer (OEM) can be securely authenticated offering counterfeit protection. This also enables Zero-Touch configuration of nodes, which enables the configuration of nodes with desired privileges, access controls, clustering, etc. due to reliable identification, in some instances, without manual intervention. The nodes may communicate through the network to obtain node information such that policy information can be specified.

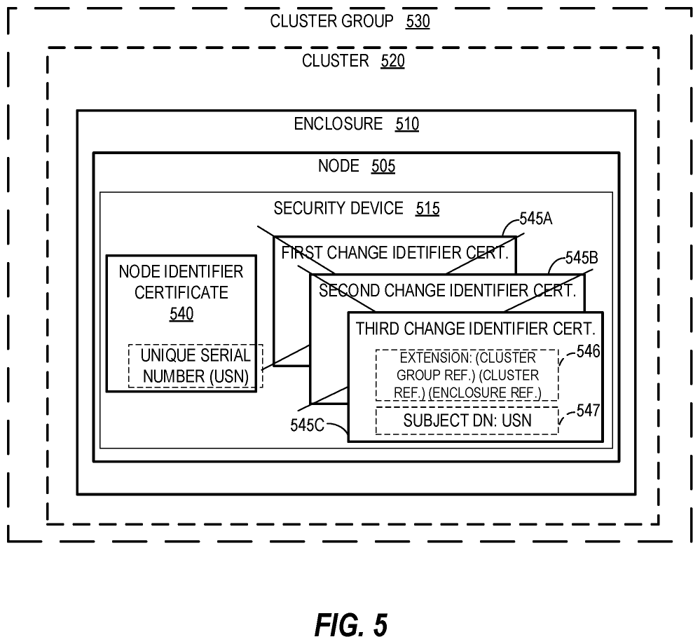

FIG. 5 illustrates a schematic view of a node with identifiers representing the hierarchical relation of a node, in accordance with various examples of the present disclosure. The node 505 may be deployed in an enclosure 510 and the node 505 may be part of one or more clusters or one or more cluster groups in a logical deployment. The node 505 may comprise a security device 515, such as a security co-processor, and/or a BMC. In some examples, a BMC can be a specialized processor configured to monitor a physical condition of a node and communicate with a network administrator/network console via a dedicated connection or an integrated connection with a communication channel of the node. The security device 515 may be configured to store a node identifier (e.g., an IDevID) and one or more change identifiers (e.g., LDevIDs) based on several phase changes that the node 505 undergoes. In the ongoing example, the node 505 may have undergone three-phase changes. That is, by way of deployment in an enclosure 510 (e.g., a first system), then in a cluster 520 (e.g., a second system), and then in a cluster group 530 (e.g., a third system).

The node 505 may include a node identifier that may be factory provisioned to the security device 515. In an example, the node identifier may be provisioned to at least one of a TPM and a BMC (not shown). At least one of the TPM and the BMC may operate as the security device 515. In a further example, the BMC may be used in a management plane and the TPM may be used when a host Operating System (OS) (e.g., OS of the node 505) uses the device identifier. In some examples, an authenticating component may be selected based on an operating condition of a node. Operating conditions may include initialization or running conditions. That is, in one example, during initialization, a BMC may act as a security device. Whereas, in an operating condition, a TPM may act as the security device. Further, the BMC may include a dedicated network interface for the management plane and access to the component authentication manager may be restricted to the dedicated network interface.

In some examples, the security device 515 can be operated using an auxiliary power source (e.g., battery, Uninterrupted Power Supply, Backup power source, or the like), so that the node 505 may not be brought into operational condition. In some examples, the BMC can be an integrated Lights Out (iLO), a Lights-Out Management (LOM), a Remote Access Controller (RAC), a Remote Supervisor Adapter (RSA), a hardware Root of Trust device (e.g., Titan, Pluton, etc.), or any other out-of-band management system. According to some examples, the node identifier may use a unique serial number of the node 505. In some further examples, the node identifier may use a unique serial number along with a combination of a model and manufacturer details. A BMC, operating as a security device 515, can provide “lights-out” functionality for nodes. The “lights-out” functionality can enable a network console to carry out administrative operations on the node 505. Furthermore, the security device 515 can provide “out-of-band” services, such as remote access, power management functions, monitoring of the system status, access to system logs, and the like.

Further, the node 505 may be provided with a first change identifier certificate 545A, when the node 505 is deployed in the first system. In some examples, a remote management service (e.g., the RMS 430 of FIG. 4) may provide the first change identifier to the security device 515. The first change identifier may incorporate a chassis serial number in a certificate extension. “Certificate extension” may be used to expand original X.509 certificate information such that identification information for the certificate may be expanded. Similarly, a Distinguished Name (DN)/subject DN may describe identifying information in a certificate and the DN can be part of the certificate itself.

In the ongoing example, the device identifier certificates, which can be X.509 certificates, may be generated using key pairs. These device identifiers may be used for electronic distribution and/or PKI. The associated private keys of these certificates may be stored locally on the node 505. In an example, the private key of the first change identifier can be in the security co-processor. In another example, the key can be stored encrypted in a local storage of the node 505. When required, the key can be loaded into the security co-processor. Also, the first change identifier certificate can be stored in the local storage. The certificate issued for the first change identifier may include an extension that stores information that uniquely identifies the first system. For example, the first change identifier certificate 545A (e.g., LDevID certificate) may have an extension (e.g., SAN extension) that stores a unique serial number of the enclosure 510. Further, a subject Distinguished Name (DN) of the first change identifier 545A may store information matching information stored in the node identifier certificate 540 (e.g., IDevID certificate). In an example, information may be copied from the subject DN of the node identifier certificate to the first change identifier certificate 545A. This enables the identification of node 505 and its hierarchical information, which can be enclosure details.

Further, the node 505 may be provisioned to be part of a cluster (e.g., a cluster 520) to support a user or an enterprise related application/service. In other words, the node 505 may be deployed in a second system, which can be the cluster 520 herein. This may be referred to as a phase change. Thus, the node 505 may receive a second change identifier certificate 545B, which can be stored in the security device 515. The second change identifier may replace an earlier change identifier (the first change identifier). Thus, the security device 515 may securely store the latest change identifier that indicates the hierarchical information of the node 505.

In a further example, the security device 515 may generate key pair for the second change identifier certificate 545B and may send a communication request for provisioning a certificate for the node 505. The communication request may be initiated by the node 505 or the RMS. Further, responsive to the reception of the new certificate (the second change identifier certificate 545B), the first change identifier certificate 545 may be revoked by an appropriate authority. In the illustrated example of FIG. 5, a change identifier/certificate that may be revoked is represented by a cross mark (X). That is, the first change identifier certificate 545A is represented by a cross mark (X) as it got replaced by the second change identifier certificate 545B, during the second phase of the node 505. The certificate of second change identifier certificate 545B may incorporate the unique serial number of the enclosure 510 and the cluster 520 in an extension field. Further, the certificate may include a subject DN that matches information incorporated in the node identifier certificate 540.

Further, during a further life cycle of the node 505, the node 505 may be part of a cluster group (e.g., a cluster group 530). This may be a phase change of the node 505. Thus, the node 505 may receive a new change identifier (e.g., a third change identifier certificate 545C). The third change identifier 545C replaces an earlier change identifier (e.g., the second change identifier certificate 545B). In the illustrative example, the second change identifier certificate 545B is represented with a cross mark (X) as it is replaced by the third change identifier 545C. Thus, the node may use the third change identifier 545C to identify and/or authenticate to an end point.

In some examples, the third change identifier certificate 545C may include a serial number of the node, a unique reference of the enclosure, a unique reference of the cluster, and a unique reference of the cluster group.

In the illustrative example of FIG. 5, the third change identifier certificate 545C may contain one or more hierarchical references/identifiers in an extension 546. In one example, the extension 546 can be a Subject Alternative Name (SAN) field of an LDevID certificate. In another example, a subject DN 547 of the third change identifier stores a unique serial number (USN) of the node 505. The unique serial number of the node 505 stored in the third change identifier 545C matches with a unique serial number stored in the node identifier 540.

In some examples, a change identifier certificate (e.g., the third change identifier certificate 545C) may contain a cryptographic signature (not shown). The cryptographic signature can be a cryptographic hash of content of the certificate and can be generated with a cryptographic hash algorithm, a private key, and the contents of the certificate. As discussed herein, the latest change identifier replaces an earlier change identifier thereby maintaining a single change identifier.

Thus, the node 505 maintains one node identifier (e.g., the node identifier certificate 540) and the latest change identifier (e.g., the third change identifier certificate 545C, as per the current example). Further, the latest change identifier may be used for various authentication use cases thereby reducing/eliminating authentication using the node identifier certificate 540. Further, an RMS, such as a storage center, may effectively distinguish the hierarchical configuration of a node (e.g., chassis details, cluster details, etc.) and accordingly grant appropriate privileges based on that configuration. For example, a node that may be part of an enclosure, but part of another cluster may be granted limited or zero access to perform operations with other member nodes deployed in the same enclosure.

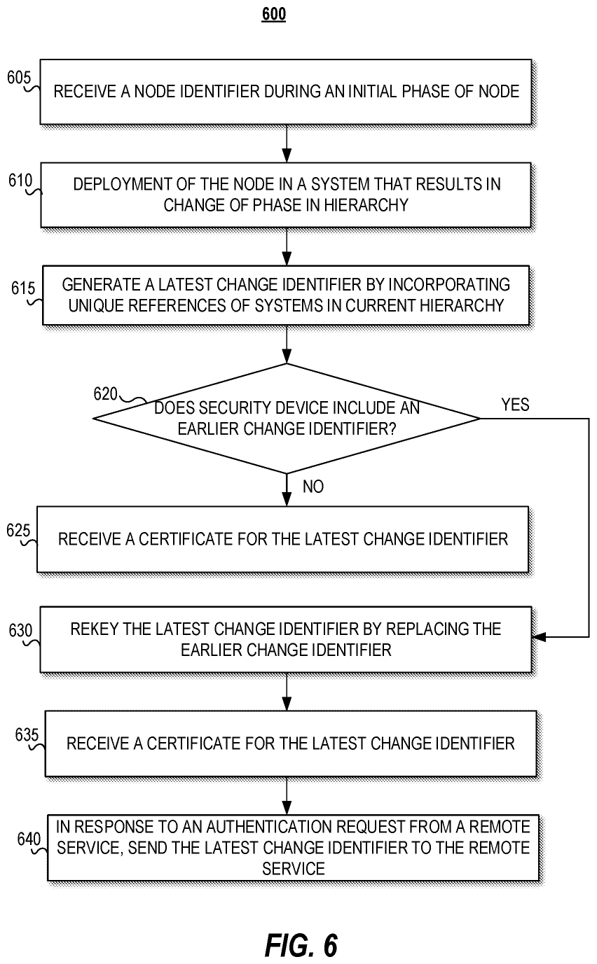

FIG. 6 illustrates a flow diagram 600 for a method of providing cryptographic identities to a node and an authentication process of the node, per various examples of the present disclosure. Although blocks shown in FIG. 6 are in a specific order, the order may not be exclusive. One or more blocks may be performed in any order, at any time, may be performed repeatedly, and/or may be performed by any suitable device or devices. The node can be a server and it may include a TPM and/or a BMC. The node may be deployed in one or more systems (physical or cluster deployment) during field deployment.

Now referring to the flow diagram 600, at block 605, the node may receive a node identifier during an initial phase of the node. The initial phase of the node may be a manufacturing or assembly phase of the node. The node identifier may be provisioned as part of the factory provisioning of a cryptographic identifier for the node.

At block 610, the node may be deployed in the latest system which may cause the node to be part of a larger system, which can be a larger physical or logical deployment. In other words, the deployment of the node in a system may result in a change of phase in a hierarchy of deployment of the node.

At block 615, the security device may generate a new key pair. The node may receive a latest change identifier by incorporating a unique reference of the latest system and one or more earlier systems in the hierarchy of deployment. For instance, “unique reference” may include a unique serial number, a dedicated reference, or a combination of one or more references. These identifier(s) may further be provided with secure identifier certificates, such as X.509 certificates. These certificates may be generated using a cryptographic identifier (e.g., IDevID/LDevID) as identifiers. For example, a private key associated with identifiers of these certificates may be securely stored in a tamper-proof manner within the security device of the node. In some examples, tamper-proof storage may be achieved through one-time programmable memory as suggested in IEEE 802.1AR: Secure Device Identity.

In accordance with one example, the node receives the node identifier, such as an IDevID from the CA during the initial factory provisioning phase of the node. The IDevID may be signed by the CA and the IDevID can be available and protected for the entire device's lifetime (e.g., until the device can be functional/operational), where the IDevID consists of an initial unique identifier of a node. According to the IEEE 802.1AR standard, the IDevID can be provisioned during the device factory manufacturing stage. In some other examples, certificates may be signed by a manufacturer, an enterprise, or a technology provider. A signing entity may ensure that public keys are indeed associated with the private keys of the requestor.

At block 620, the security device or a processor of the node may check if an earlier change identifier is included. That is, the security device may check if the node includes a change identifier that incorporates any hierarchical information of the node prior to the current deployment. In one example, the security device may check if an LDevID may be available.

At block 625, based on a condition that the security device does not include a change identifier, the security device may generate a key pair and the node may receive a latest change identifier, which can be a first change identifier of the node. The node may receive a certificate for the latest change identifier. In conditions such as a node undergoing an initial deployment in a system (e.g., chassis) or a node that may have been decommissioned from earlier deployments and provisioned to a new system may qualify for such reception of certificate.

At block 630, based on a condition that the security device includes a change identifier (e.g., the earlier change identifier as mentioned in block 620), the security device or a processor of the node may replace the (earlier) change identifier with the latest change identifier. For example, the earlier change identifier can be an LDevID that stores hierarchical information of one or more previous phases of the node. Whereas, the latest change identifier may store hierarchical information of the one or more previous phases along with the current phase information. The security device may rekey the latest change identifier that replaces the earlier change identifier of the node.

At block 635, the node may receive a certificate of the latest change identifier. For example, a CA may sign an identifier (e.g., the latest change identifier). In a specific example, the latest change identifier, such as an LDevID, may comprise a key pair and the CA may issue a certificate/sign a public key out of the key pair. Thus, every time the node undergoes a phase change, a new change identifier is issued that replaces an earlier change identifier and a certificate is issued to the latest change identifier.

At block 640, in response to an authentication request from a management service, the node may send the latest change identifier to the management service. In some examples, the node and an end point, such as the management service or RMS, may use a mutual authentication protocol based on public key certificates, such as LDevID certificates, as per the present disclosure. In some other examples, an IEEE 802.1X based authentication may be used. The IEEE 802.1X uses Extensible Authentication Protocol (EAP) for message exchange during the authentication process. In some further examples, an EAP-TLS type authentication may be used that uses certificates for identification and/or authentication. During the EAP-TLS authentication, the node may use the single change identifier (e.g., the latest change identifier) that is available on the node for authentication.

In some examples, the latest change identifier can be a latest LDevID issued to the node. The latest change identifier enables identification of the node as a genuine component deployed in a specific chassis, cluster, and so forth. In one example, the node can be a storage node that can use this single cryptographic identity (e.g., the latest change identifier) for various authentication use cases. Endpoints can distinguish a node based on hierarchical configuration such that appropriate privileges can be granted.

Furthermore, in accordance with the illustrative example, the security device of the node receives a reissued/new LDevID from the CA during the logical deployment phase (e.g., clustering phase) of the node. During the logical deployment phase, the node may be deployed in a second system. The second system may be at least one of a cluster of nodes, a cluster of servers, a cluster of storage nodes, a cluster of storage systems, a logical storage system, etc. The reissued/new LDevID consists of a first unique identifier of the first system and a second unique identifier of the second system. Further, the security device may check and determine when a change in the phase of the node has occurred. Based on such determination, the security device may retrieve the second unique identifier corresponding to the second system. Further, the processor may trigger a request to receive a second certificate for the second change identifier by communicating the second unique identifier corresponding to the second system.

In a particular example, the method illustrated in the flow diagram 600 may further include blocks at which, a node may generate a new LDevID key pair during every phase change. The node may request an LDevID certificate. The latest LDevID certificate may result in the revocation of an earlier LDevID certificate(s).

Blocks 605-640 as illustrated in FIG. 6 can be instructions stored in a non-transitory storage medium, such as the storage medium 135 of FIG. 1. The instructions can be executed by a processor that causes the processor to perform one or more actions as discussed in blocks 605-640. The processor and the non-transitory storage medium can be part of a node, such as the node 105/305/306/405/505 discussed earlier.

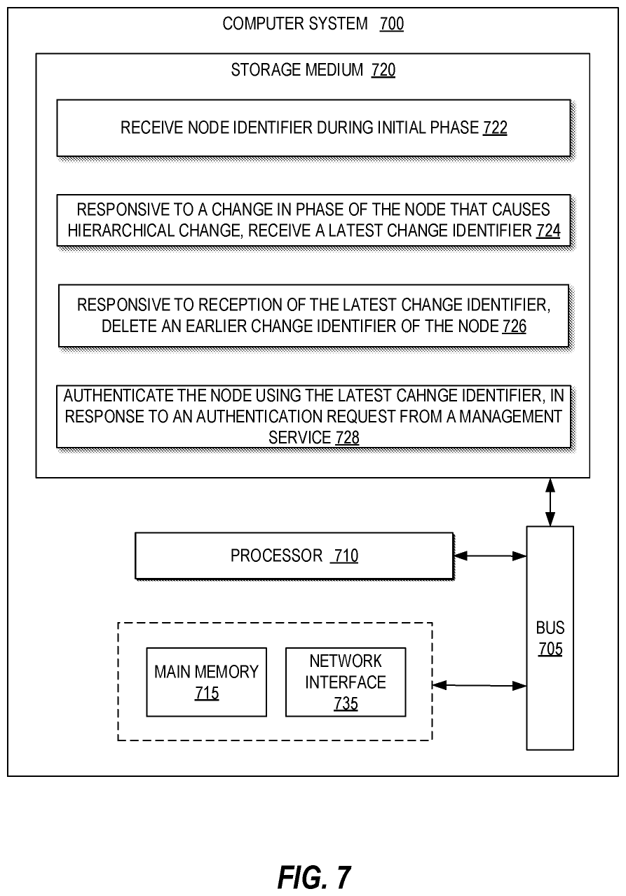

FIG. 7 depicts a block diagram of an example computer system 700 in which the disclosed hierarchical authentication/identification techniques may be implemented. Furthermore, it should be appreciated that although the various instructions are illustrated as being co-located within a processor, one or more instructions may be executed remotely from the other instructions.

The computer system 700 may include a bus 705 or other communication mechanisms for communicating information, one or more processors 710 coupled with bus 705 for processing information. Processor(s) 710 may be, for example, one or more general-purpose microprocessors. The computer system 700 also may include a main memory 715, such as a random access memory (RAM), cache, and/or other dynamic storage devices, coupled to a bus for storing information and instructions to be executed by the processor 710. Main memory 715 also may be used for storing temporary variables or other intermediate information during the execution of instructions to be executed by processor 710.

In some examples, the techniques herein are performed by computer system 700 in response to processor(s) 710 executing one or more sequences of one or more instructions contained in main memory 715. Such instructions may be read into main memory 715 from another storage medium, such as storage medium 720, which is a non-transitory type. Execution of the sequences of instructions contained in main memory 715 causes processor(s) 710 to perform the process steps described herein. In alternative examples, hard-wired circuitry may be used in place of or in combination with software instructions. In some examples, the computer system 700 may include a security co-processor, such as a TPM, for generating key pair and signing operations. Such a security co-processor can be independent of the processor(s) 710. In some other examples, the computer system 700 may include a Baseboard Management Controller (BMC) that includes a security sub-system, such as a security co-processor. The BMC may be independent of the processor(s) 710. The sub-system of the BMC may generate key pairs and sign.

The term “non-transitory,” and similar terms, as used herein may refer to any media that store data and/or instructions that cause a machine to operate in a specific fashion. The computer system 700 also may include a network interface 735 that provides a two-way data communication coupling to one or more network links that are connected to one or more local networks. Network interface 735 may be a local area network (LAN) card to provide a data communication connection to a compatible LAN (or WAN component to communicate with a WAN). Wireless links may also be implemented. In any such example, network interface 735 may send and receive electrical, electromagnetic, optical signals, or other forms of signal that carry digital data streams representing various types of information.

The computer system 700 can send messages and receive data, including program code, through the network(s), network link, and communication interface. In the Internet example, a server might transmit a requested code for an application program through the Internet, the ISP, the local network, and the communication interface. In some examples, received code may be executed by processor 710 as it can be received, and/or stored in storage medium 720, or other non-volatile storage for later execution.

The storage medium 720 may store instructions, executable by the processor 710, to perform one or more actions as per the present disclosure. According to some examples, the instructions 722 may cause the processor, to receive a node identifier during an initial phase of the node. The node identifier comprises an initial unique identifier of the node. Further, the instructions 724 may cause the processor, to, responsive to a change in phase of the node that causes hierarchical change, receive a latest change identifier. The phase change may cause the hierarchical change as the node may become part of an additional system. In other words, “hierarchical change” may include the node being deployed in a further system, which adds to the hierarchical relation of deployment of the node. The latest change identifier may incorporate a latest unique identifier corresponding to a latest system and one or more unique identifiers corresponding to one or more earlier systems at the node may be deployed.

The instructions 726 may cause the processor, to, responsive to the reception of the latest change identifier, and delete an earlier change identifier. In an example, the earlier change identifier may be replaced by the latest change identifier with updated hierarchical information. The instructions 728 may cause the processor, to authenticate the node/computer system 700 using the second change identifier, in response to an authentication request for authentication of the node by a management service. In some further examples, instructions, may cause the processor, to request a latest certificate for the latest change identifier and receive the latest certificate signed by a certification authority. The instructions may cause the processor, to revoke the earlier certificate by a certification authority. The latest change identifier certificate may be used for authentication of the node.

Wherever possible, the same reference numbers may be used in the drawings and the following description to refer to the same or similar parts. While several examples are described in the description, modifications, adaptations, and other examples are possible. Accordingly, the detailed description does not limit the disclosed examples. Instead, the proper scope of the disclosed examples may be defined by the appended claims.

Throughout the drawings, identical reference numbers may designate similar, but not necessarily identical, elements. An index number “N” appended to some of the reference numerals may be understood to merely denote plurality and may not necessarily represent the same quantity for each reference numeral having such an index number “N.” Additionally, use herein of a reference numeral without an index number, where such reference numeral is referred to elsewhere with an index number, may be a general reference to the corresponding plural elements, collectively or individually.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in various ways. Different combinations and sub-combinations are intended to fall within the scope of this disclosure, and certain methods or process blocks may be omitted in some examples.

In general, the word “device,” “component,” “system,” “database,” “data store,” and the like, as used herein, can refer to logic embodied in hardware or firmware, or to a collection of software instructions, possibly having entry and exit points, written in any known programming language. Software components configured for execution on computing devices may be provided on a computer-readable medium.

While several examples are described in this document, modifications, adaptations, and other examples are possible. Accordingly, the following detailed description does not limit disclosed examples. Instead, the proper scope of the disclosed examples may be defined by the appended claims. The terminology used herein can be to describe particular examples and can be not intended to be limiting. As used herein, the singular forms “a,” “an,” and “the” are intended to include the plural forms as well, unless the context clearly indicates otherwise. Also, the terms “includes,” “including,” “comprises,” “comprising,” “have,” or “having” when used in this disclosure specify the presence of the stated elements, but do not preclude the presence or addition of other elements.

The term “another,” as used herein, can be defined as at least a second or more. The term “coupled,” as used herein, can be defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein may refer to and encompasses any and all possible combinations of the associated listed items. It will also be understood that, although the terms first, second, third, fourth, etc. may be used herein to describe various elements, these elements should not be limited by these terms, as these terms are only used to distinguish one element from another unless stated otherwise or the context indicates otherwise. As used herein, the term “includes” means includes but is not limited to, the term “including” means including but not limited to. The term “based on” means based at least in part on.

What is claimed is:

1. A method comprising:
receiving, by a processor of a node, a node identifier during an initial phase of the node, wherein the node identifier incorporates an initial unique identifier of the node;
receiving, by the processor, a first change identifier during a first phase change of the node, wherein during the first phase change, the node is deployed in a first system, and wherein the first change identifier incorporates a first unique identifier corresponding to the first system;
receiving, by the processor, a second change identifier during a second phase change of the node, wherein during the second phase change, the node is deployed in a second system, and wherein the second change identifier incorporates the first unique identifier corresponding to the first system and a second unique identifier corresponding to the second system; and
sending, by the processor, the second change identifier to a management service for authentication of the node, in response to an authentication request from the management service.

2. The method of claim 1, wherein receiving the first change identifier, includes:
generating a first key pair for the first change identifier;
requesting, by the processor, certificate for the first change identifier; and
receiving, by the processor, a first certificate for the first change identifier, wherein the first certificate binds the first unique identifier of the node to a public key of the first key pair.

3. The method of claim 1, wherein receiving the second change identifier, includes:
generating a second key pair for the second change identifier;
requesting, by the processor, certificate for the second change identifier;
receiving, by the processor, a second certificate for the second change identifier, wherein the second certificate binds the first unique identifier and the second unique identifier to a public key of the second key pair; and
rekeying, by the processor, the second change identifier by deleting the first change identifier.

4. The method of claim 3, further includes:
revoking a first certificate, responsive to reception of the second certificate.

5. The method of claim 1, wherein receiving the second change identifier during the second phase change of the node, includes:
determining, by the processor, a change in phase of the node;
triggering, by the processor, a security co-processor to generate a second key pair; and
requesting, by the processor, to receive a second certificate of the second change identifier by communicating the second unique identifier corresponding to the second system.

6. The method of claim 1, wherein:
the first system is a chassis, and the node is deployed on the chassis; and
the chassis includes a memory unit communicatively coupled to the node and the memory unit stores a unique identifier corresponding to the chassis.

7. The method of claim 5, wherein the security co-processor is at least one of a Trusted Platform Module (TPM), and Baseboard Management Controller (BMC) deployed on the node.

8. The method of claim 1, wherein the node identifier is an Initial Device Identifier (IDevID), and wherein the initial phase is a manufacturing phase of the node.

9. The method of claim 1, wherein the first change identifier and the second change identifier are Locally significant Device Identifiers (LDevIDs), and wherein the first phase change and the second phase change correspond to deployment phases of the node.

10. The method of claim 1, wherein the second change identifier is a Locally significant Device Identifier (LDevID) that is reissued, and wherein the second phase change is due to at least one of a physical deployment or a logical deployment of the node.

11. The method of claim 1, wherein the second system is at least one of a cluster of nodes, a cluster of servers, a cluster of storage nodes, a cluster of storage systems, and a logical storage system.

12. The method of claim 1, wherein the management service is at least one of a cloud-based management server, another node, a remote node, a server, a computing node, a client node, a monitoring node, a portable device, a non-portable device, a management console, and a central monitoring system.

13. A node comprising:
a processor; and
a non-transitory storage medium storing instructions, the instructions executable by the processor that cause the processor to:
receive a node identifier during an initial phase of the node, wherein the node identifier comprises an initial unique identifier of the node;
receive a first change identifier during a first phase change of the node, wherein during the first phase change, the node is deployed in a first system, and wherein the first change identifier incorporates a first unique identifier corresponding to the first system;
receive a second change identifier during a second phase change of the node, wherein during the second phase change the node is deployed in a second system, and wherein the second change identifier incorporates the first unique identifier corresponding to the first system and a second unique identifier corresponding to the second system; and
send the second change identifier to a management service for authentication of the node, in response to an authentication request from the management service.

14. The node of claim 13, wherein the instructions to receive the first change identifier includes further instructions that cause the processor to:
receive a first certificate for the first change identifier, wherein the first certificate includes an extension field that incorporates the first unique identifier.

15. The node of claim 13, wherein the instructions to receive the second change identifier includes further instructions that cause the processor to:
receive a second certificate for the second change identifier, wherein the second certificate includes an extension field that incorporated the first unique identifier and the second unique identifier for hierarchical identification of the node.

16. The node of claim 13, wherein the first system is at least one of a physical deployment or a logical deployment of the node.

17. The node of claim 13, wherein the first system is at least one of a chassis, a group of chassis, a rack server, a blade server, and a group of physical nodes.

18. A non-transitory storage medium storing instructions, the instructions, executable by a processor, to:
receive a node identifier during an initial phase of a node, wherein the node identifier comprises an initial unique identifier of the node;
receive a latest change identifier during a phase change of the node, wherein the phase change causes a hierarchical change, and wherein the latest change identifier incorporates a latest unique identifier corresponding to a latest system and one or more unique identifiers corresponding to one or more earlier systems the node is deployed in;
responsive to reception of the latest change identifier, delete an earlier change identifier; and
authenticate the node using the latest change identifier, in response to an authentication request from a management service.

19. The non-transitory storage medium of claim 18, wherein the instructions to receive the latest change identifier includes instructions to:
request a latest certificate for the latest change identifier; and
receive the latest certificate signed by a certification authority.

20. The non-transitory storage medium of claim 18, wherein the instructions to delete the earlier change identifier includes instructions to:
revoke an earlier certificate by a certification authority.
